(19) United States
(12) Patent Application Publication
(10) Pub. No.: US 2011/0202384 A1
(43) Pub. Date: Aug. 18, 2011

(54) Enterprise Rendering Platform

(76) Inventor: Wayne S. Rabstejnek, Alpharetta, GA (US)

(21) Appl. No.: 12/860,151

(22) Filed: Aug. 20, 2010

Related U.S. Application Data
(60) Provisional application No. 61/305,328, filed on Feb. 17, 2010.

(51) Int. Cl. G06Q 10/00; G06F 3/048

(52) U.S. Cl. 705/7.26; 715/760

(57) ABSTRACT

According to one non-limiting embodiment, an enterprise rendering platform for providing ERP functionality for a computing device having a web browser includes at least one ERP system storing enterprise data on at least one server. A rendering workbench provides a GUI-based editor in which executable metadata for at least one selected ERP function is presented to a setup user, and in which a view for executing the ERP function may be created with no coding. A repository stores the view and the executable metadata for the view. The gateway invokes an execution engine to execute the ERP function to retrieve ERP data and renders the view to include the retrieved ERP data. The rendered view is sent to a remote user for display in a web browser on a computing device

The application claims priority to U.S. Provisional Application No. 61/305,328 which was filed on Feb. 17, 2010.

### BACKGROUND

This application relates to enterprise resource planning (“ERP”) software, and more particularly to an enterprise rendering platform for executing ERP functionality on a computing device having a web browser.

Many companies use ERP software such as SAP and Oracle to manage corporate data across multiple departments and/or geographic locations. A given ERP software package may have many thousands of possible functions that can be invoked by custom programs. Prior art systems for accessing ERP data on mobile devices have selected a small subset number of these functions and have created device-specific code to invoke the selected functions such that a limited number of mobile devices have been able to access ERP data. This approach is costly and time-consuming.

### SUMMARY

According to one non-limiting embodiment, a method of providing ERP functionality to a computing device having a web browser organizes selected inputs and outputs of a selected ERP function into an application view in a rendering editor wherein no coding is required to create the view. User input is received from a computing device. The selected ERP function is executed on an ERP system in response to the user input. The view is rendered on a computing device gateway, and the rendered view includes data received from the ERP system via the selected ERP function. The computing device gateway is remote from the computing device. The rendered view sent to a remote user for display in a web browser on the computing device.

According to one non-limiting embodiment, an enterprise rendering platform for providing ERP functionality for a computing device having a web browser includes at least one ERP system storing enterprise data on at least one server. A rendering workbench provides a GUI-based editor in which executable metadata for at least one selected ERP function is presented to a setup user, and in which a view for executing the ERP function may be created with no coding. A repository stores the view and the executable metadata for the view. The gateway invokes an execution engine to execute the ERP function to retrieve ERP data and renders the view to include the retrieved ERP data. The rendered view is sent to a remote user for display in a web browser on a computing device.

According to one non-limiting embodiment, a method of executing ERP functionality on a computing device having a web browser receives login credentials from a remote user of a computing device and determines a user role and an assigned ERP user instance in response to the login credentials. A menu to be displayed to the remote user is dynamically determined based upon the remote user's assigned role and the remote user's assigned group. A menu selection is received from the remote user, the menu selection selecting a view operable to execute an ERP function on an ERP system. A view definition for the ERP function is retrieved from a repository database. An execution engine is invoked to command the ERP system to execute the selected ERP function using executable metadata corresponding to the view definition. An indication of the invoking of the execution engine is dynamically formatted for presentation in a browser on the computing device.

According to one non-limiting embodiment, a method of creating a view for providing ERP functionality for a computing device having a web browser presents a list of available inputs and outputs for a selected ERP function to a remote user and receives a selection of at least one specified input and at least one specified output of the selected ERP function. The selected inputs and outputs of the selected ERP function are organized into a view in a rendering editor wherein the remote user may create the view without providing any code. The view is operable to command an ERP system to invoke the selected ERP function on behalf of a computing device.

These and other features of the present invention can be best understood from the following specification and drawings, the following of which is a brief description.

### BRIEF DESCRIPTION OF THE DRAWINGS

FIG. 1 schematically illustrates an enterprise rendering platform for executing ERP functionality on a computing device having a web browser.

FIG. 1a schematically illustrates example computer hardware that may be used in the platform of FIG. 1.

FIG. 1b schematically illustrates example contents of a repository of the platform of FIG. 1.

FIGS. 2-3 schematically illustrate a method of creating a view and of executing the view to access an ERP system.

FIG. 4 schematically illustrates a plurality of example user roles and example menu groups.

FIG. 5 illustrates an example back end connection definition screen.

FIGS. 6-7 illustrate a plurality of example menus.

FIG. 8 illustrates parameters of an example ERP function.

FIG. 9 illustrates an example view creation screen.

FIG. 10 illustrates an example view input definition screen.

FIG. 11 illustrates an example view output definition screen.

FIG. 12 illustrates an example view output layout definition screen.

FIG. 13-14 illustrate example search link creation screens.

FIGS. 15-16 illustrate example output link creation screens.

FIG. 17 illustrates an example view input screen.

FIG. 18 illustrates an example search screen for a field of the view of FIG. 17.

FIG. 19 illustrates the view of FIG. 17 having its search field populated.

FIG. 20 illustrates example ERP data retrieved from the view of FIG. 17.

### DETAILED DESCRIPTION

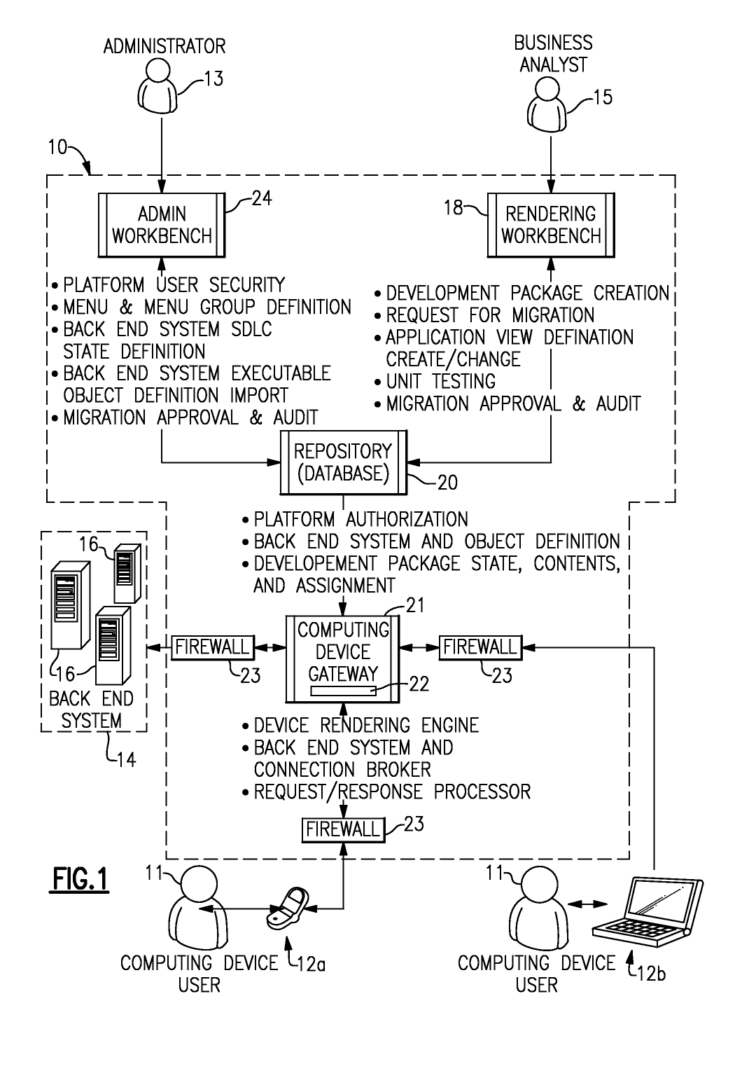

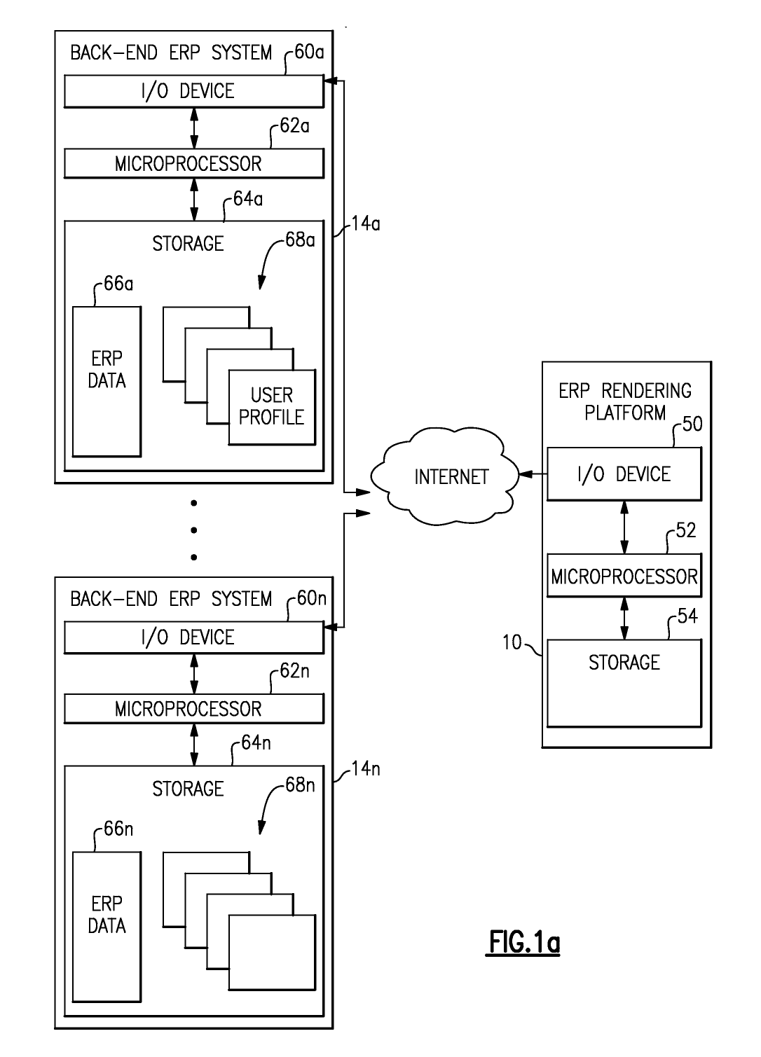

FIG. 1 schematically illustrates an enterprise rendering platform 10 for executing ERP functionality on a computing device 12 having a web browser. Some example computing devices include a mobile phone 12a or a laptop 12b. Of course, other computing devices having a web browser could be used, including a personal digital assistant (“PDA”), tablet computer, iPad, e-reader (e.g. the Amazon Kindle) or a desktop computer, for example. However, it is understood that these are only examples and that any computing device having a web browser could be used with the platform 10.

The platform 10 is operable to communicate with at least one back end ERP system 14. Some example ERP systems include SAP, PeopleSoft and Oracle. However, it is understood that these are only examples, and that other ERP systems could be used. The ERP system 14 stores enterprise data on one or more servers 16. Although only a single ERP system 14 is illustrated, as will be described below, the platform 10 may be configured to connect to a plurality of different ERP systems.

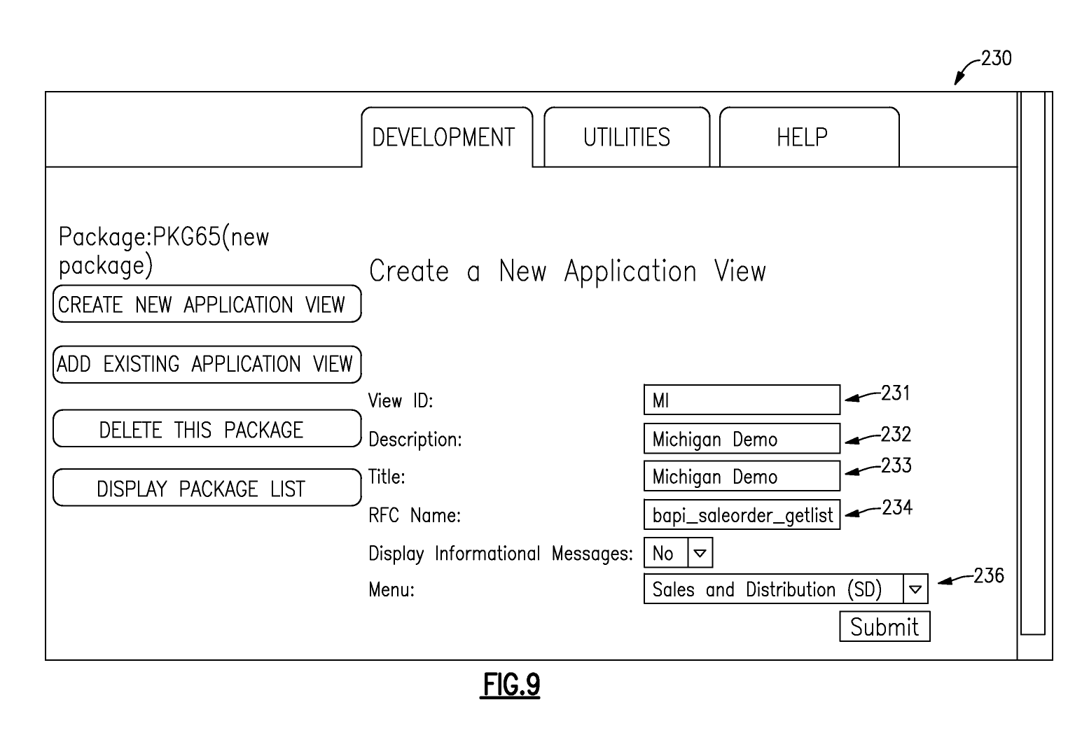

A rendering workbench 18 provides a GUI-based editor (see FIGS. 9-16) in which executable metadata for at least one selected ERP function of the ERP system 14 is presented to a business analyst 15 (e.g. “setup user”), and in which a view (see FIG. 17) for executing the ERP function using the executable metadata may be created through a visual interface without requiring the business analyst 15 to perform any coding.

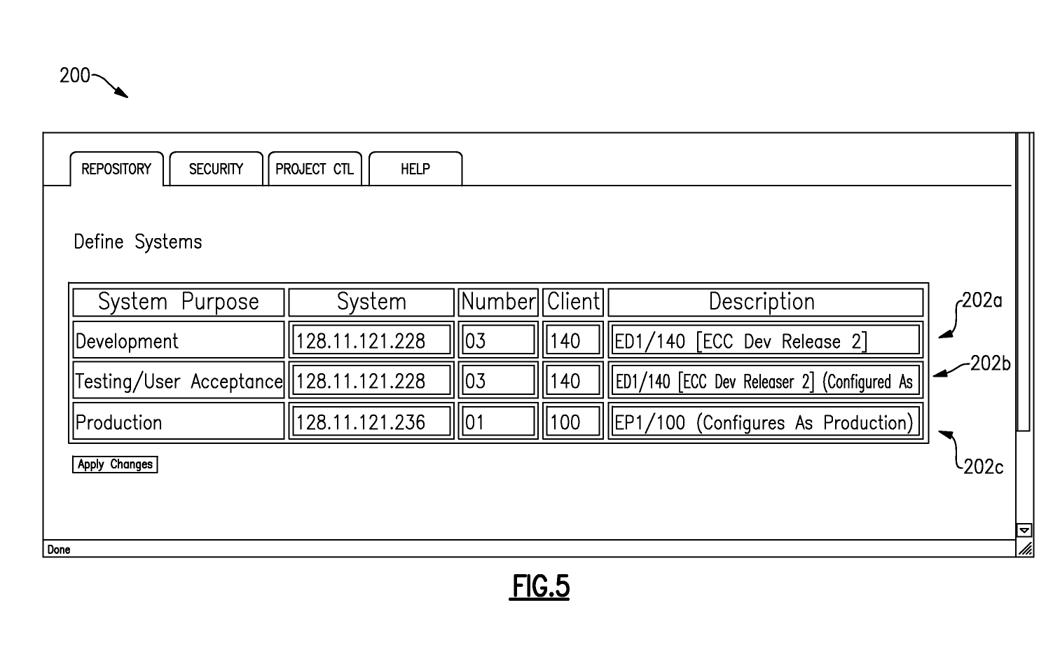

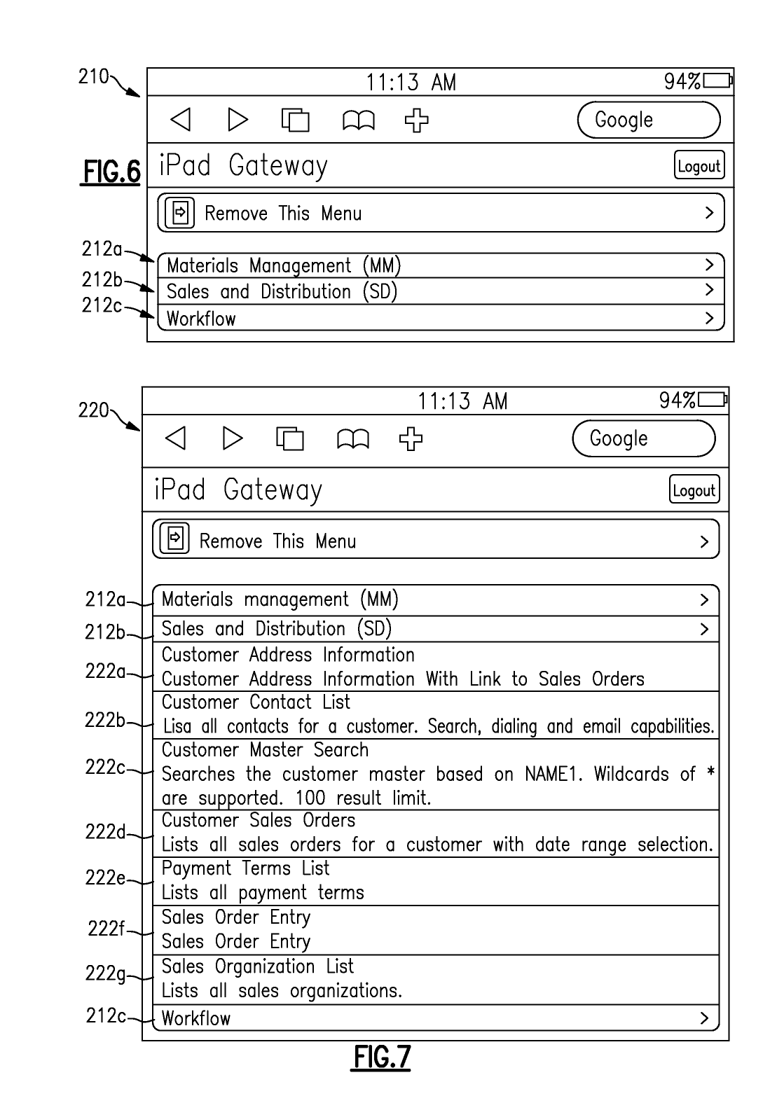

A repository 20 stores the view and the executable metadata for the view (see view definitions 86 in FIG. 1b). A computing device gateway 21 is operable to establish a connection with the ERP system 14 on behalf of the computing device 12. The gateway 21 invokes an execution engine 22 to execute the selected ERP object to retrieve ERP data, and to render the view to include the retrieved ERP data. The gateway 21 also formats the view for a browser on the computing device 12. An administrative workbench 24 facilitates the creation of menus from which views can be invoked (see FIGS. 6-7), and facilitates various software development lifecycle (“SDLC”) features. Although the rendering workbench 18, repository 20, gateway 21, and administrative workbench 24 are shown as separate components, it is understood that they could be located on a single server if desired. Alternatively, the items 18, 20, 22, 24 could be located on a plurality of servers.

FIG. 1a schematically illustrates example computer hardware that may be used in the platform 10 of FIG. 1. As shown in FIG. 1a, the platform 10 includes at least one input/output (“I/O”) device 50, at least one microprocessor 52, and at least one storage device 54. The platform 10 is operable to connect to a plurality of back end ERP systems 14a-n through the Internet 56, for example. Of course, other wide-area networks (“WANs”) or local area networks (“LANs”) could be used to connect the platform 10 to the ERP systems 14a-n. Each of the ERP systems 14a-n includes an I/O device 60, at least one microprocessor 62 and a storage device 64. The storage devices 54, 64 could include memory, hard drives, or any electronic, optical, magnetic or other type of computer storage, for example. As shown in FIG. 1a, each storage device 64 may include ERP data 66 and a plurality of ERP user profiles 68 for the users 11.

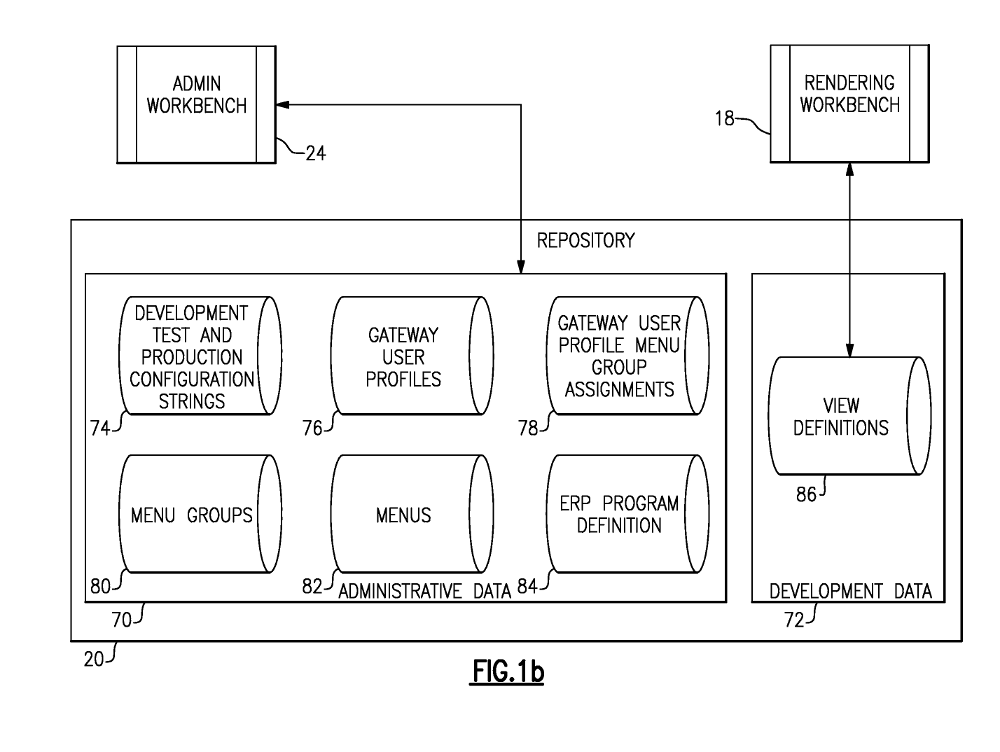

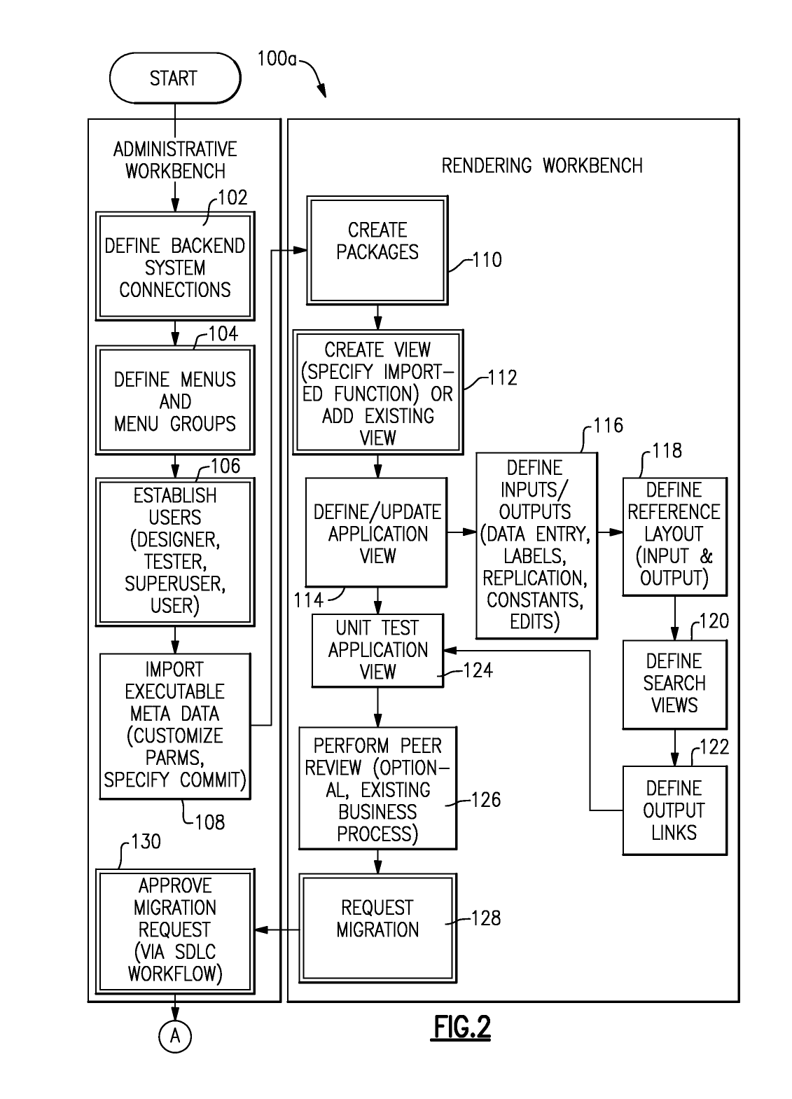

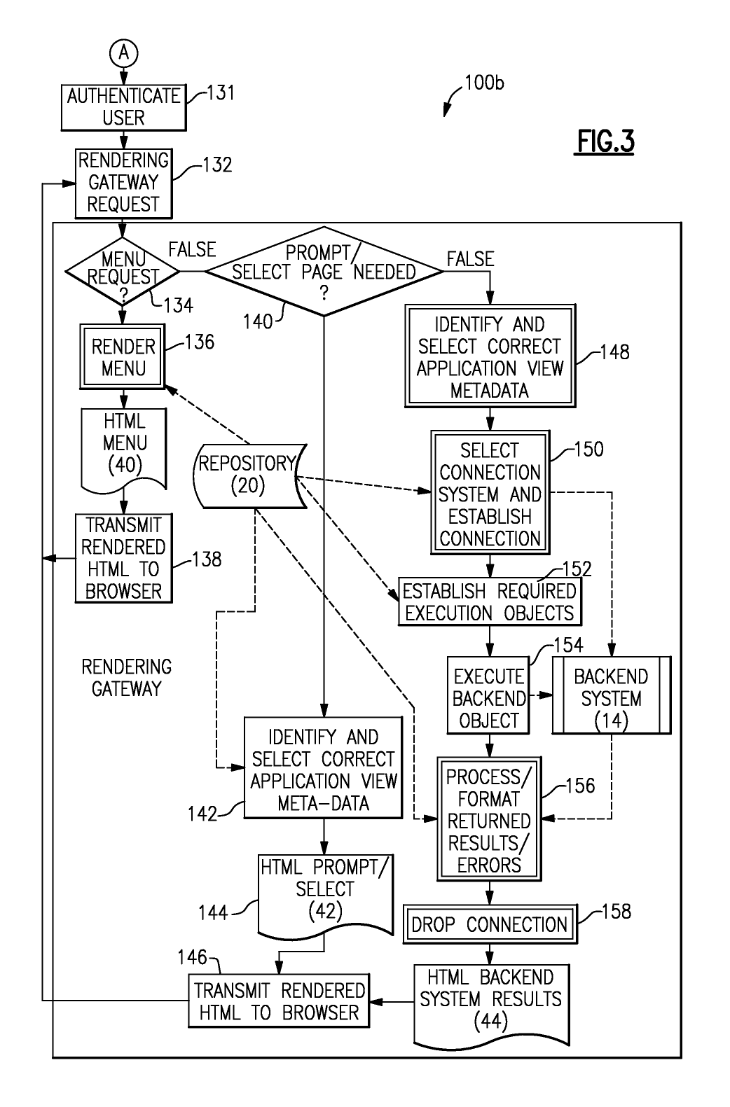

FIGS. 2-3 schematically illustrate a method 100 of creating a view and of executing the view to access the ERP system 14. FIG. 2 schematically illustrates a first portion 100a of the method 100, and FIG. 3 schematically illustrates a second portion 100b of the method 100. As shown in FIGS. 2-3, steps 102-108 and 130 may be performed using the administrative workbench 24, steps 110-128 may be performed using the rendering workbench 18, and steps 134-158 may be performed using the rendering gateway 21.

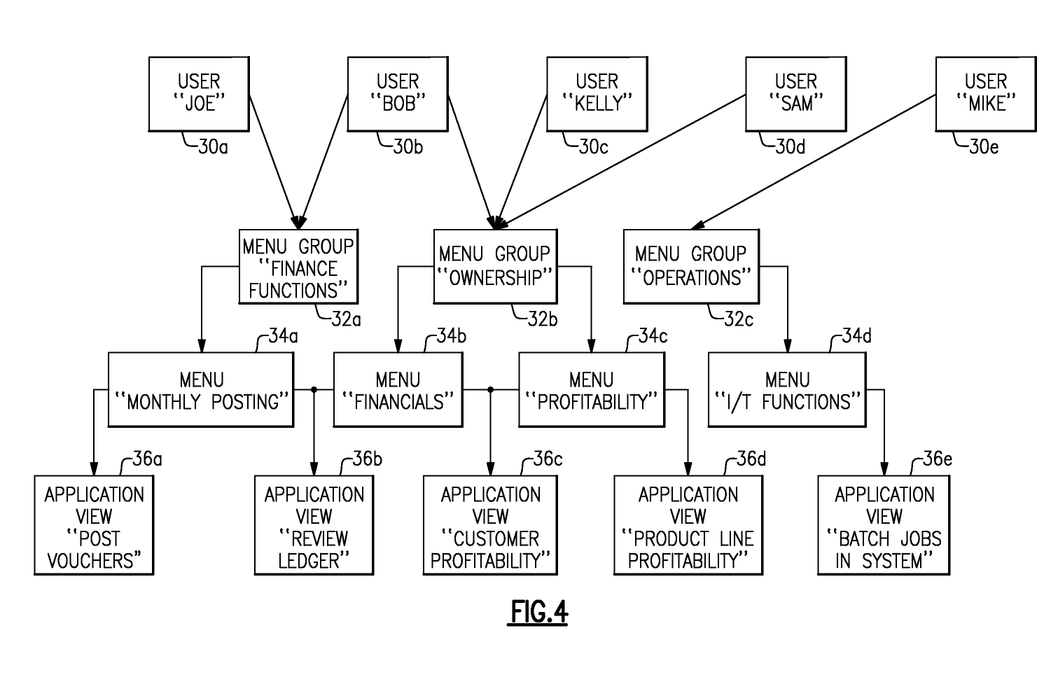

Referring to FIG. 2, at least one connection to a back end ERP system 14 is defined (step 102). FIG. 5 schematically illustrates an example back end ERP system connection definition screen 200 that includes a plurality of ERP connections 202a-c. The connections 202 may connect to multiple instances of a single ERP system. Thus, the development connection 202a, testing/user acceptance connection 202b, and production connection 202c may connect to different instances of a single ERP system (e.g. SAP). Step 102 may also include defining a connection to multiple ERP systems (e.g. SAP and Oracle). As shown in FIG. 5, the connections 202 may include information such as an IP address, client number, description, etc.

Referring again to FIG. 2, one or more menus, optionally organized into one or more menu groups, are created (step 104). In the platform 10, menus may be used to provide users with a list of views that can be invoked from the user's respective computing device 12. FIG. 6 schematically illustrates a screen 210 including a plurality of example menus 212a-c. If a user invoked menu 212b, for example, a plurality of views 222a-g within the menu 212b could be displayed (see screen 220 of FIG. 7). Although no menu groups are illustrated in FIGS. 6-7, it is understood that the menus 212a-c could be organized into a menu group, and that menu groups could be used as containers for menus. In one example step 104 may include enabling or disabling existing menus instead of creating new menus.

A plurality of users is established (step 106). FIG. 4 schematically illustrates a plurality of example user roles and example menu groups. Each of a plurality of users 30a-e has an assigned role (e.g. Joe is a User, Bob is a User, Sam is a SuperUser, etc.). Each of the users is granted access to at least one menu group 32a-c. Each of the menu groups 32a-c permits its users 30a-e to access one or more menus 34a-d, which in turn permit its users 30a-e to access one or more views 36a-b. For example, Joe (user 30a) is granted access to “Finance Functions” (menu group 32a) and a single menu “Monthly Posting” (menu 34a). Within “Monthly Posting”, Joe is able to access views “Post Vouchers” (view 36a) and “Review Ledger” (view 36b). As another example, Bob (user 30b) is granted access to both “Finance Functions” (menu group 32a) and “Ownership” (menu group 32b). This enables Bob to access menus 34a-c, and views 36a-d.

A user's role determines what versions of views 36 are presented to the user 30 within the selection of views available within the user's assigned menu group 32. For example, if Joe (user 30a) who is a “User” selected the “Review Ledger” view 36b Joe may be presented with a production version of the view. If Sam (user 30d) who is a “SuperUser” selected the “Review Ledger” view 36b, Sam may be presented with a test version of the view that has not yet been approved for all users. Thus, while a group determines what views are presented to a user, a user's role determines which view version is presented to the user 30.

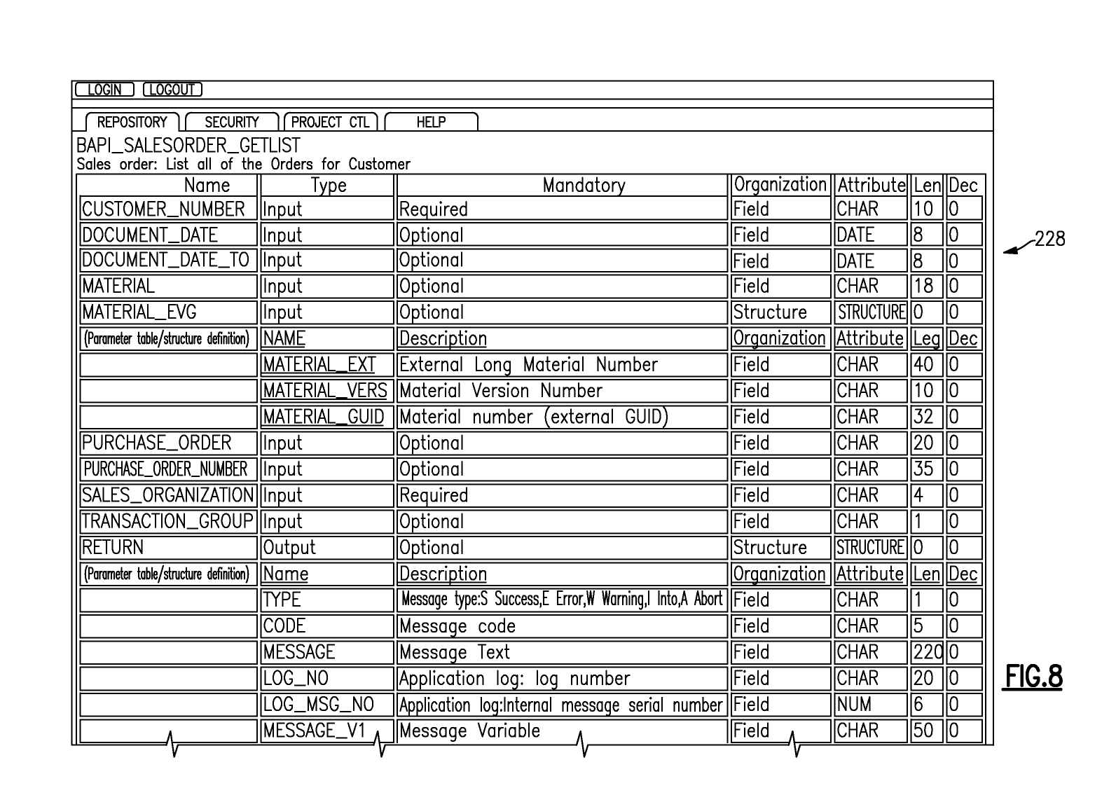

Referring again to FIG. 2, executable metadata is imported from one or more ERP functions and is stored in the repository 20 (step 108). The ERP system 14 has a plurality of functions. SAP, for example, includes 10,000+ functions that may be invoked to perform various tasks. FIG. 8 illustrates some of the parameters 228 of an example ERP function entitled “BAPI_SALESORDER_GETLIST.” Although the ERP function of FIG. 8 is an SAP Business Application Programming Interface (“BAPI”), as described above, the ERP system 14 does not have to include SAP, and the ERP function could include a remote function call (“RFC”) object, an Oracle catalog object, or another system catalog object, for example, and does not need to include a BAPI.

A package is created to group together one or more views (step 110). The package may be used when migrating views between SDLC states (e.g. testing, production, etc.) such that all views in a package are migrated as a group.

A view is created for the package of step 110 to include the functionality of a selected one of the imported ERP functions from step 108, or an existing view is added to the package of step 110 (step 112). The view may then be either defined (if the view is new) or updated (if the view is a preexisting view) (step 114). FIG. 9 illustrates an example view creation screen 230 in which a user may provide view identification attributes such as a view ID 231, a view description 232, and a view title 233. Also a user may also indicate an ERP function 234 that the view will invoke (shown as “RFC” name in the example of FIG. 9) and may indicate a menu 236 from which the view may be selected. In one example step 114 also includes performing a check to ensure that no other business analysts 15 are working on the same view, and to ensure that the proposed view name is unique and is not already being used by another view.

Once an ERP function is selected, the business analyst 15 is presented with a list of available inputs and outputs for the selected ERP function (step 116). FIG. 10 schematically illustrates an example view input definition screen 240 in which a user can indicate a parameter use 242. The parameter use 242 may be used to include (or “specify”) desired inputs or and to exclude undesired inputs as “Not Used.” Some parameters may be indicated as both “Input and Output.” Each parameter may also have an assigned parameter label 244 (e.g. “Sales Organization” and “Date From”), an input transformation 246, and an expression 248. In one example, the assigned parameter labels 244 are used when the view to which they belong is displayed in a web browser on the computing device 12. The input transformation 246 may optionally be used to assign formatting constraints, such as right, left or center justification, or the absence or presence of leading zeros. The expression 248 may optionally be used to indicate a hard-coded value or reserved word (e.g., a date, time, username, sequence value, or any other predefined word or number).

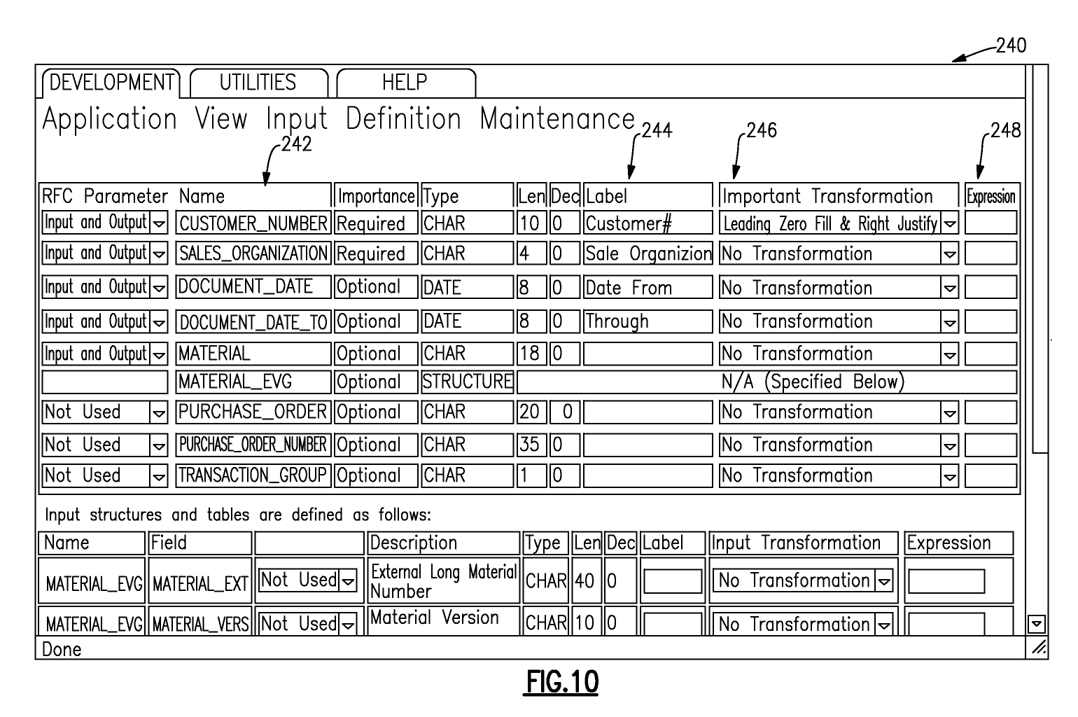

In a similar fashion to the screen 240 of FIG. 10, FIG. 11 illustrates an example view output definition screen 250 in which a parameter use 252, parameter label 254, and output transformation 256 may indicated.

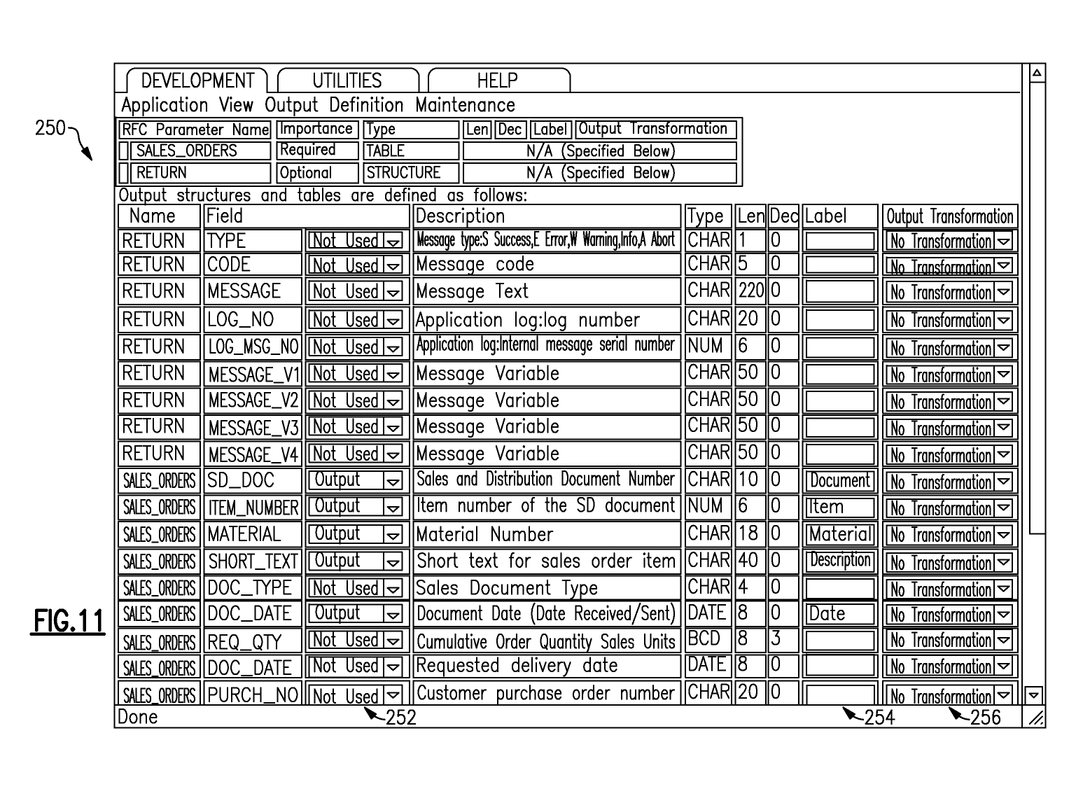

Once inputs and outputs have been selected for the view (step 116), a layout of the input and output for the view may be indicated (step 118). FIG. 12 illustrates an example output view layout screen 260 that includes plurality of columns 262 and a plurality of rows 264. In the screen 260 a business analyst 15 may select a location for a selected field (the field being assigned to an input or output parameter) by specifying a desired row and column. For example, the field “Customer #” is assigned to column 262a and row 264a. A list 266 of unassigned fields may be presented to notify the business analyst 15 of fields that still need to be given a location. An input view layout could be created in the same fashion as is illustrated in the screen 260 of FIG. 12. In one example the screen 260 is a drag-and-drop interface in which fields can be freely moved using a click-and-drag input such as a mouse or touchpad. In one example the step 118 is optional and the platform 10 could automatically generate a default input view layout and a default output view layout for a view without input from the business analyst 15.

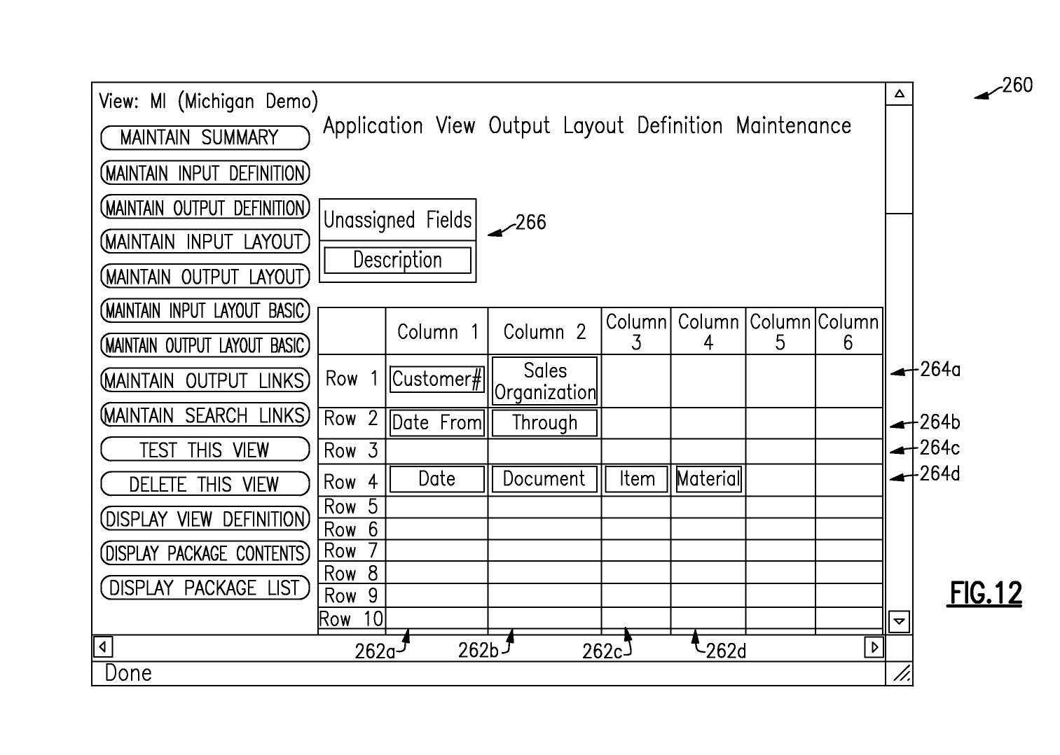

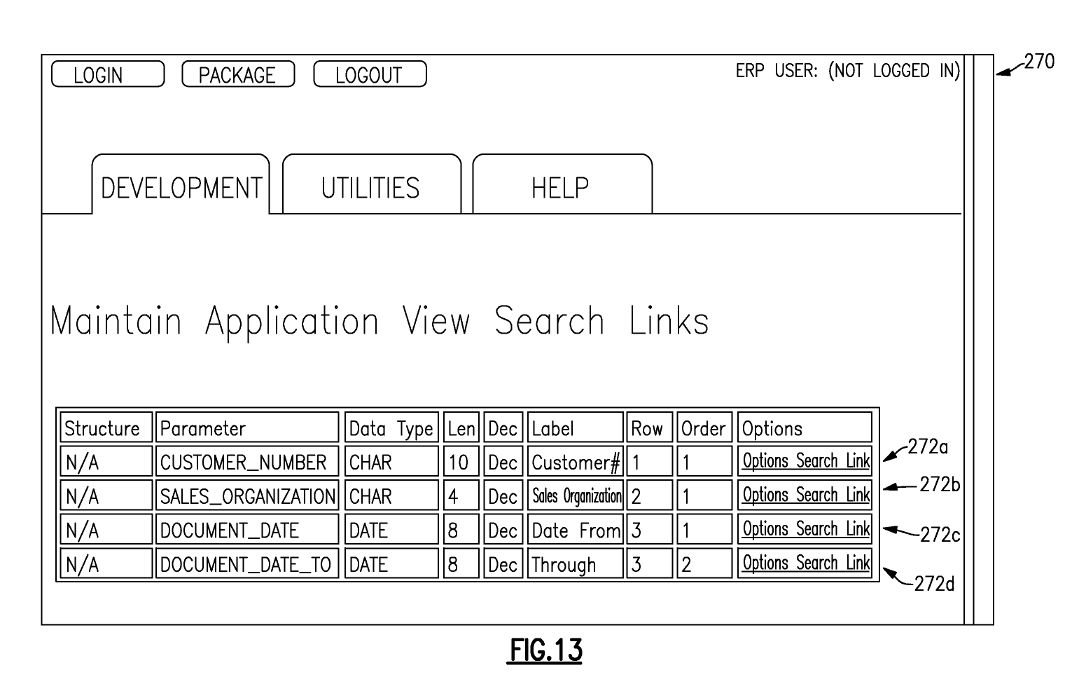

Referring to FIG. 2, one or more search views may be assigned to an input field (step 120). Step 120 may include creating a new view to act as a search view, or may include designating an existing view as a search view to perform a desired search. FIG. 13 illustrates an example search link creation screen 270 displaying a plurality of example fields 272 from which a search link may be created. If a business analyst 15 wanted to create a search link from the “CUSTOMER_NUMBER” field 272a they could click the corresponding link (shown as “Create Search Link”), and then screen 280 could be presented (see FIG. 14). The screen 280 indicates the selected parameter 282 (in this example “CUSTOMER_NUMBER”) and provides an input field 284 within which the business analyst 15 may enter a desired search view (e.g. “sc01”). Step 120 may also include presenting a business analyst with a plurality of options for the search view (e.g. similar to the options 242, 244, 246, 248 shown in FIG. 10).

When the view having the search link is executed (e.g. “Michigan Demo” view—see FIG. 17), and a user 11 (“remote user”) selects the base search field having the search link (e.g. “CUSTOMER_NUMBER”), the search view may be invoked (e.g. “sc01”) which in turn may invoke the selected ERP function associated with the search view to obtain a list of values for the input field, and that list of values may be presented to the user 11. Once a value selection is received from the user 11, the selected value may be populated into the input field. In one example the user 11 may select a desired search result by clicking a “SELECT” link or button adjacent to the desired search result (e.g. similar to how “Create Search Link” is shown in FIG. 13 next to available search links).

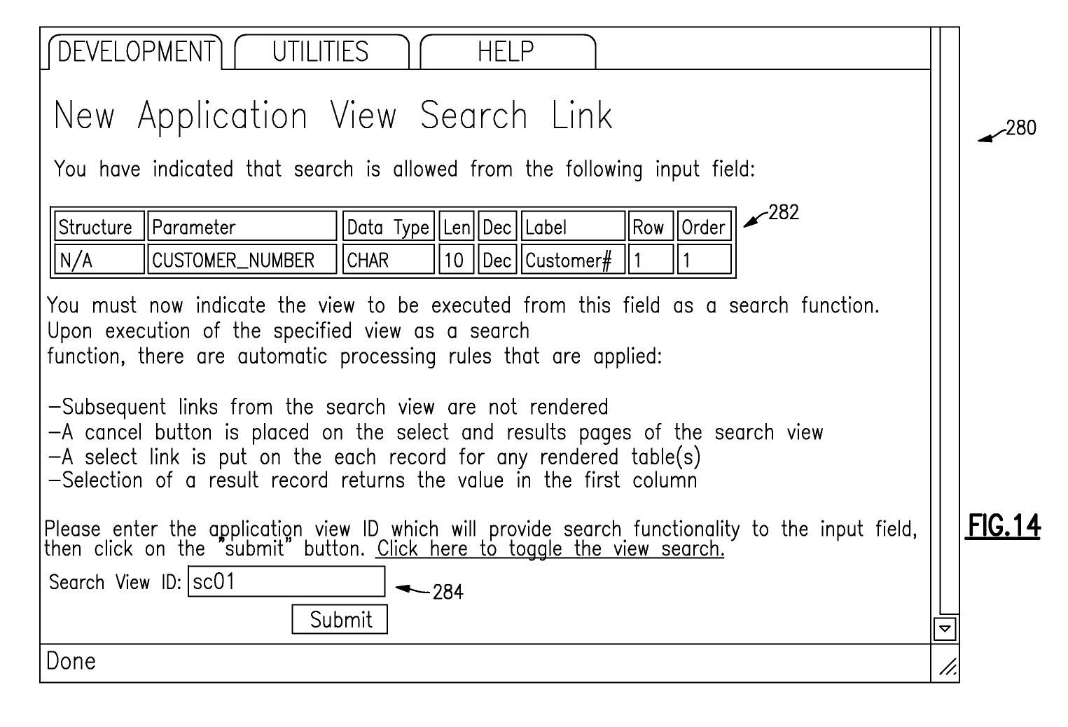

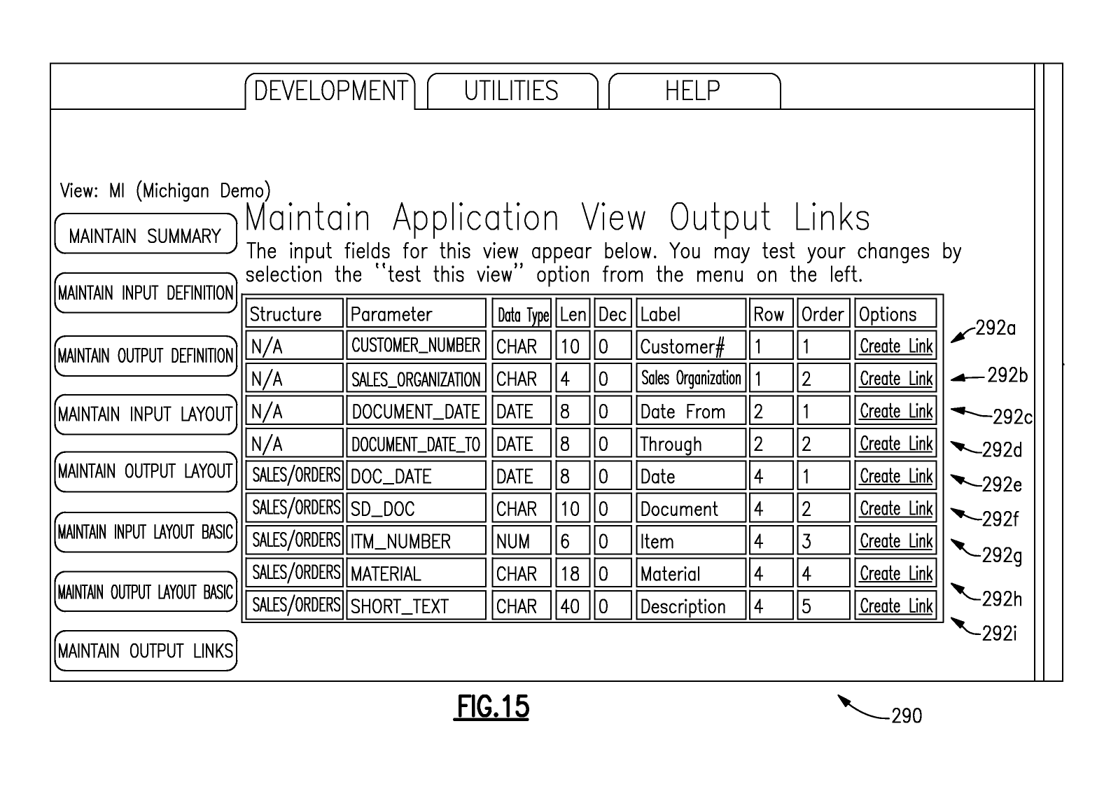

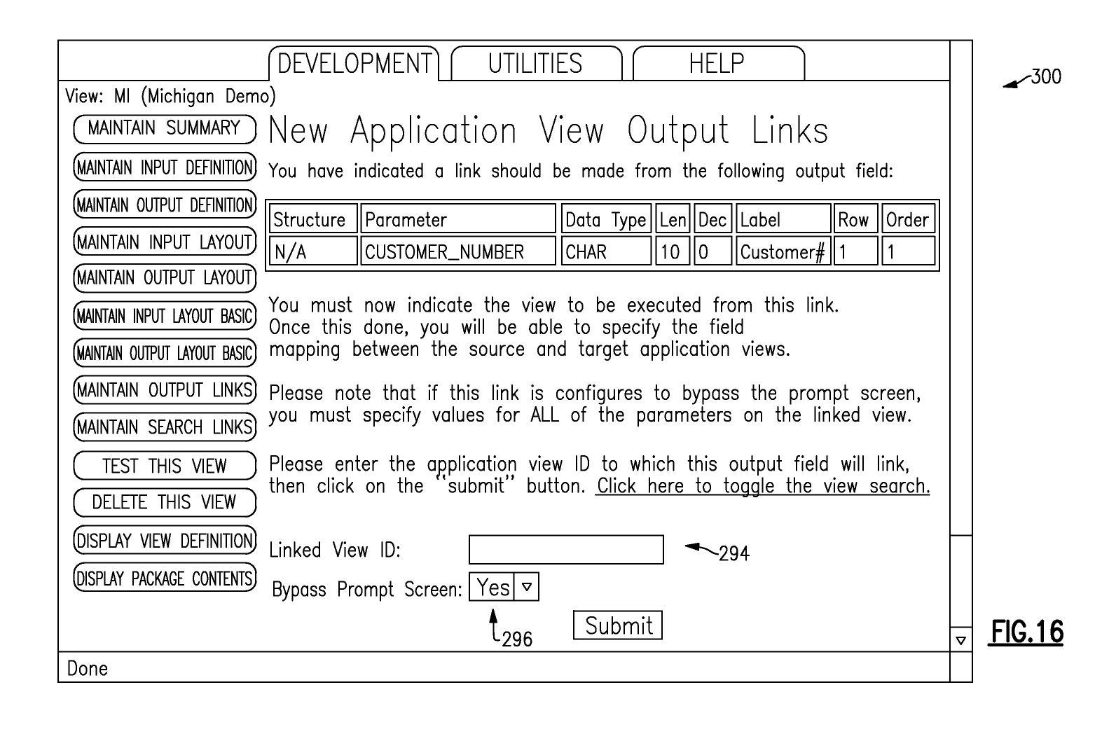

In step 122 one or more output links may be created to determine what view is invoked by a selected view. FIG. 15 illustrates an example view output creation screen 290 displaying a plurality of example fields 292a-i from which an output link may be created. If the business analyst 15 wanted to create an output link from the “CUSTOMER_NUMBER” field 292a they could click the corresponding link 292a (shown as “Create Link”), and then screen 300 (see FIG. 16) could be presented. The screen 300 indicates the selected parameter 292 (in this example “CUSTOMER_NUMBER”) and provides an input field 294 within which the business analyst 15 may enter a desired output view (e.g. as shown in field 284 in FIG. 14). A bypass prompt screen input 296 may also be included such that at runtime the user 11 is not prompted before proceeding with invoking the selected output view. Step 122 may also include presenting a business analyst with a plurality of options for the search view (e.g. similar to the options 242, 244, 246, 248 shown in FIG. 10).

In steps 124-130 the created or modified view may be migrated between states. Initially the created or modified view may be assigned a “development” state in which the view may be created and/or modified by the business analyst 15, and may be “unit tested” by the business analyst 15. Then the view may be migrated from the “development” state to a “testing” state by the business analyst 15, and in the “testing” state the view could be “system/acceptance tested” by the business analyst 15 (step 124) to perform more robust testing on the view in an environment with additional testing data. Optionally, the view may be peer reviewed to test performance with existing processes (e.g. existing internal quality assurance procedures for a group or organization) (step 126). Assuming the view passed its testing procedures in its test state, migration to another state may be requested (e.g. a “production” state) by the business analyst 15 (step 128) and may be approved (step 130) by the administrator 13. In one example step 130 may involve migrating a package containing the view from a test state (viewable by those having the “Test” or “SuperUser” role) to a production state (viewable by those having the “User” role).

FIG. 3 schematically illustrates a method of presenting the view of FIG. 2 in a menu and executing the ERP function associated with the view. For the sake of steps 131-158 we will assume that multiple menus have been created, each of those menus having views in a production state. Referring to FIG. 3, a user is authenticated (step 131). Step 131 may include receiving a platform 10 username and platform 10 password from a user 11. In one example the platform 10 username and platform 10 password are the same username and password that the user uses to connect to the back end ERP system 14 such that the user 11 need not be asked for separate login credentials for the platform 10 and the ERP system 14. In one example the user 11 has separate login credentials for the platform 10, for a first ERP system 14a, and for at least one second ERP system 14n (see FIG. 1a) such that multiple username and password prompts may be presented to the user 11.

A rendering request is received (step 132) from a browser on the computing device 12. A check is performed to determine if the request is a menu request or a view request (step 134). If the request is a menu request, the menu will be rendered (step 136), and a rendered HTML menu 40 (see, e.g., FIGS. 6-7) is transmitted to a web browser on the mobile device 12.

However, if the request of step 132 is not a menu request, then a check is performed to determine if the user needs to be prompted (step 140). If the user must be prompted (e.g. view requires some user input), then the executable metadata for the selected ERP function of the selected view will be identified and rendered (step 142) and the rendered HTML view 42 will be transmitted to the browser of the computing device 12 (step 146).

However, if no user input is required, or if the required user input has already been received, then the applicable metadata associated with the selected ERP function will be identified (step 148), and the gateway 21 will establish a connection with the back end ERP system 14 on behalf of the computing device 12 (step 150). The one or more objects to be executed are identified and retrieved from the repository 20 (step 152). The back end ERP system 14 then executes the ERP function associated with the selected view (step 154). The back end ERP system 14 returns information to the gateway 21 (step 156), the connection of step 150 is terminated (step 158), the HTML back end results are rendered as HTML 44 (step 160), and the rendered HTML is transmitted to the browser on computing device 12 (step 146).

Unlike prior art ERP systems that establish a connection with an ERP system and maintain that connection through many transactions, the platform 10 is operable to establish a connection (step 150) and terminate the connection (step 158) such that the connection with the ERP system 14 is only maintained long enough for a single view to be executed and for that view's output to be rendered as HTML. However, unlike the prior art, much shorter connection times may be performed without giving the user the impression of interrupted service. For example, in prior art systems with longer connection times if a mobile user went out of cell range, ran out of battery power, or encountered another situation that caused the mobile device to become, a so-called “hanging connection” with the ERP system 14 may linger, consuming ERP system 14 resources and potentially requiring administrator attention to terminate the connection. Certain aspects of the platform 10 will now be discussed in greater detail.

Views

In the platform 10, a view (see screen 310 FIG. 17) is an encapsulated definition of some ERP system functionality (e.g. the ERP function BAPI of FIG. 8). A view definition 86 is a runtime description stored in the repository 20 that is interpreted at execution by the execution engine 22 on the gateway 21. As described above, a view definition 86 (see FIG. 1b) includes executable metadata for at least one selected ERP function, including a selection of input and output parameters to be used in the execution. This may include constants, formulas, conversions, and user-entered values (see FIGS. 8, 10-11). The view may also include a layout definition of how the selection and results pages will be presented to the user 11 (see FIG. 12). The view definition 86 may also include search or lookup functionality to allow the user 11 to provide required information (e.g., material identification, customer number, payment term code, etc.) (see FIGS. 13-14). The view definition 86 may also include a preference for how informational messages will be handled (e.g. display or don't display informational messages). The view definition may include a menu from which the view may be invoked (see FIGS. 6-7) and may include one or more links to other views (see FIG. 16).

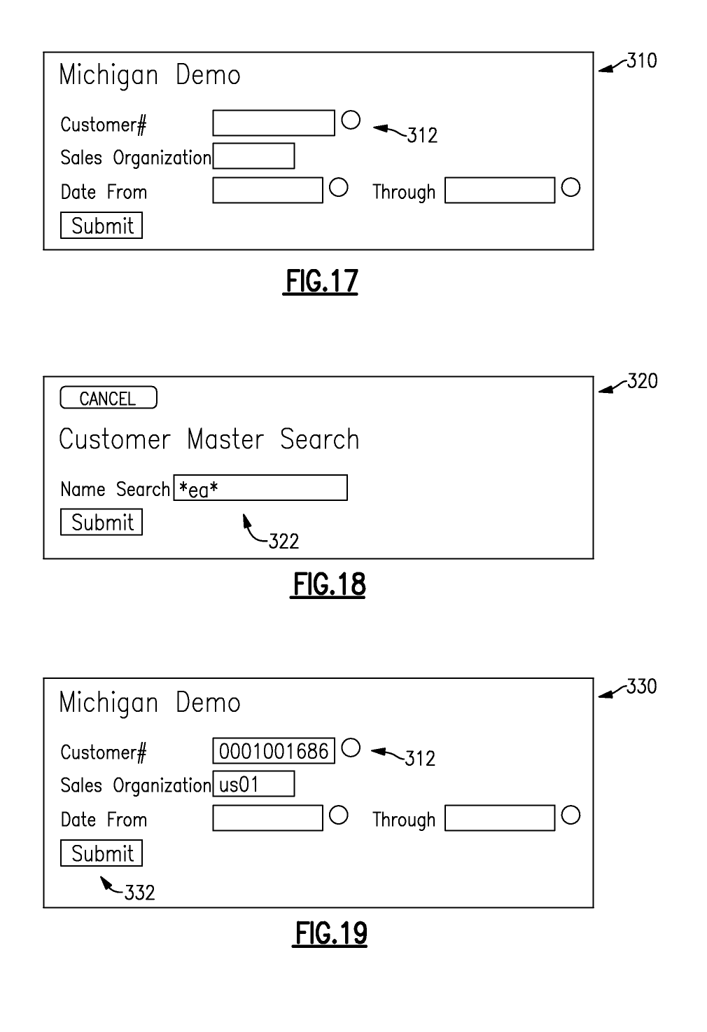

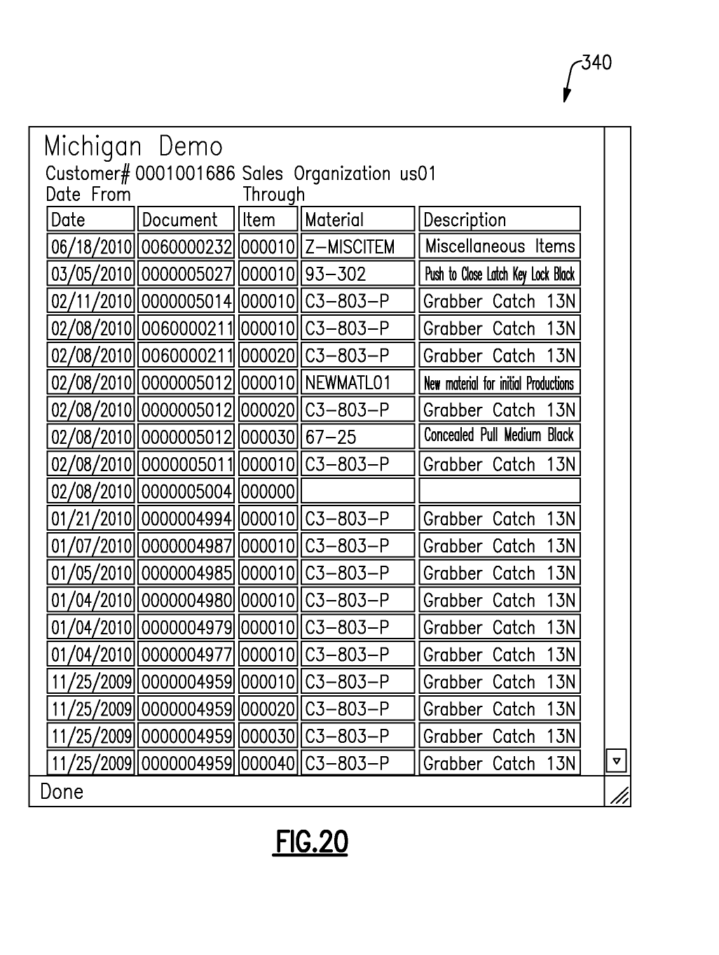

FIGS. 17-20 illustrate an example execution of a view. Screen 310 of FIG. 17 shows an example view entitled “Michigan Demo.” The view includes a search field 312 entitled “Customer #” which if invoked presents screen 320 to a user 11. In the screen 320, a user can input search criteria 322 (e.g. “*ea*” for field “Name Search”, with asterisks used as wildcards) and a list of results containing “ea” could be returned along with associated values for those results. For example entities named “Team” and “Outreach” (which both include “ea”) could be listed along with a value associated with each of the entities. The user 11 could then select a desired one of the entities (e.g. by clicking a “SELECT” button next to the desired entity) and the value associated with the selected entity could be populated into the field. FIG. 19 illustrates a screen 330 in which the field 312 is populated with a value “0001001686” which may have been the result of a search of screen 320. Thus, the search field 312 could be used to retrieve a customer number by searching for a customer name, for example. When the user 11 invokes the “Submit” button 332 the view is executed and the ERP function associated with the view is invoked by the execution engine 22, resulting in the rendered HTML screen 340.

Execution Engine

The execution engine 22 is an interpretive component of the platform 10 that facilitates real-time, dynamic execution of a selected ERP function without the need for creating custom code to execute the selected ERP function. The execution engine 22 establishes a connection with an appropriate ERP instance on the ERP system 14 on behalf of the computing device 12 (step 150), prepares all parameters for invoking a selected ERP function (step 154), receives resulting data from the ERP system (step 156), and renders the HTML that is transmitted to computing devices 12 (steps 138, 146, 160).

The execution engine 22 may also be operable to perform exception and error handling between the computing device 12 and the back end ERP system 14. The execution engine 22 may also be operable to perform technical commit and/or rollback processing if the selected ERP function is initiating an update to the back end ERP system 14 and the update undesirably resulted in an error.

As described above, the execution engine 22 may also handle connections with the ERP system 14 in a unique manner by only initiating a connection (step 150) if interaction with the ERP system 14 is required, and by terminating the connection (step 158) after that interaction is complete, such that the “hanging connection” issue prevalent in the prior art is not an issue with the platform 10.

Since the connections made with the ERP system 14 are dynamically made in real-time, the information presented to the users 11 via computing devices 12 is presented in real-time as well.

Administrative Workbench

Access to the administrative workbench 24 may be limited to administrators 13 (i.e. those with a role of “administrator”). Some example functions of the administrative workbench 24 include maintaining the repository 20, configuring security, and controlling view migration (see “Virtual SDLC” section below).

From the standpoint of the repository 20, the administrative workbench 24 may configure the connections for development, testing/user acceptance, and production instances of the back end ERP system 14 (see FIG. 5). The administrative workbench 24 may also be used to import and configure executable metadata for selected ERP functions (see FIGS. 10-11), which may include identifying which functions require support for automatic commit and rollback. The administrative workbench 24 may also be used to define and maintain non-delivered menus 212 and menu groups (see FIGS. 6-7).

From the standpoint of security, the administrative workbench 24 maintains user profiles 76 and user roles, and maintains user menu group assignments 78 for access to the platform 10.

Rendering Workbench

In the rendering workbench 18, a business analysts 15 may create and maintain views, may discard views and/or packages of views, may request migration between SDLC states, and may generate hard-copy documentation of a view (e.g. a document including a list of inputs, outputs, labels, links, menus, etc. for a given view). If a view is already in production, the business analyst 15 may check out the view and may begin concurrently working on a development version of the production view. The business analyst 15 may also perform unit testing on a view within the rendering workbench 18. As described above, the rendering workbench 18 may be a “code-free” environment such that the business analyst 15 can create and maintain views and perform the tasks described above (e.g. requesting view migration and generating view documentation) without writing any code.

Computing Device Gateway

The computing device gateway 21 relays information between computing devices 12 and the ERP system 14. Once logged in to the gateway 21, a user 11 can select a view from a menu that the user 11 is authorized to view. Also, users 11 can change their platform 10 passwords. To execute a view, a user 11 provides their login credentials for the platform 10 and for the ERP system 14. The view definition 86 identifies which ERP system 14 that the view will connect to (e.g. SAP, Oracle, etc.), and the user's role determine which instance of the ERP system (e.g., testing, production, etc.) that the user connects to on the ERP system 14. Thus, a single gateway 21 can support connections to development, production and testing instances of an ERP system 14.

Repository

The repository 20 is a database that stores information used by the execution engine 22 to execute a view. FIG. 1b schematically illustrates example contents of the repository 20. The repository includes both administrative data 70 and development data 72. The administrative data 70 may include configuration settings 74, gateway user profiles 76 (e.g. the profiles of users 11 for the platform 10), gateway user profile menu group assignments 78, menu groups 80 and menus 82 (see FIGS. 6-7), and ERP program definitions 84, for example. The development data 72 may include view definitions 86.

For security purposes, no ERP login credentials are stored in the repository 20. All ERP connections are made using login credentials provided by users 11 through the gateway 21. In one example, the gateway 21 only stores ERP login credentials in memory while a user 11 is logged in, and removes the ERP login credentials from memory after the user 11 logs off to enhance security.

Virtual SDLC

The administrator 13 serves as the gatekeeper to the movement of a package of one or more views between SDLC states (e.g., development, testing, user acceptance testing, quality assurance, production, etc.). In one example the user who creates and alters a view (e.g. business analyst 15) cannot be the same person who approves the view (e.g. administrator 13).

In the platform 10, software development lifecycle (“SDLC”) states are logical states, rather than corresponding to multiple physical locations. Thus, while a view is in production, it may also be in either a development or testing/acceptance state. To support this configuration, each view includes a state indicator. The execution engine 22 dynamically retrieves the appropriate version of a view based upon the gateway user profile 78 of a user 11 (see FIG. 1b).

The platform 10 may include the SuperUser role, within which the user 11 may be given access to production views unless a non-production version of a view was available, in which case the user 11 accesses the non-production version of the view.

Some of the elements of FIGS. 2-3 are illustrated to include a double border (e.g. steps 102, 104, 106, 110, etc.). This double border indicates an example collection of steps that are involved in the virtual SDLC process. Of course, other SDLC steps could be used.

“No Coding” View Creation

As described in connection with steps 112-122, a user may create a view by selecting from a plurality of available inputs and outputs and by indicating desired attributes of those inputs and outputs (e.g., labels, transformations, etc.) such that no coding is required. Thus, the platform 10 requires no programming knowledge on the behalf of administrators 13, business analysts 15 or users 11, requires no changes to back end ERP systems 14, and requires no code to be stored on computing devices 12.

Thus, the platform 10 is unlike prior art ERP mobile device connectivity systems that did one or more of the following: (1) required installing ERP software on a computing device in addition to a web browser, (2) provided wizard-based connectivity for a very limited subset of ERP functions, or (3) required ERP function-specific and device-specific code such to be written such that that a limited number of mobile devices were to access a limited amount of ERP data.

Also, although steps 112-122 describe a drop-down menu-based system of specifying executable metadata for a selected ERP function for a view, it should be understood that other no-coding methods could be included, such as a drag-and-drop interface.

Zero Device Footprint

Because all interaction between the computing device 12 and the platform 10 is performed via a browser on the computing device 12, no ERP-specific software needs to be installed on the computing device 12 to access the administrative workbench 24, the rendering workbench 18, or to interact with the ERP system 14. All data may be rendered as HTML such that a user only needs to use the browser on their computing device 12 to interact with the platform 10. Although no ERP-specific software needs to be installed on the computing device 12, it is understood that ERP-specific software may be installed on a server hosting the platform 10 (e.g. JDBC, ODBC, or other database connection software) to facilitate communication with the ERP system 14.

Also, no custom code needs to be installed and no custom modifications need to be made to the back end ERP system 14. Under the Sarbanes-Oxley regulatory framework, corporations may need to perform extensive validation on their ERP systems. Prior art ERP mobile connectivity systems required modification to existing ERP systems 14, which in turn required repeating the extensive validation of their ERP systems. The platform 10, however, simply executes business functionality that has already been validated and exists only in the validated ERP instance. Thus, the platform may connect to a previously validated ERP systems 14 such that the ERP system 14 does not need to be revalidated, making Sarbanes-Oxley compliance easier to maintain.

Localization

As described above, step 131 may include receiving a platform 10 username and a platform 10 password from a user 11, and the username and password may be the same username and password that the user would use to connect to the ERP system 14. The username and password may be used to retrieve a gateway user profile 76 from the ERP system 14. The gateway 21 may use the profile 76 to provide localization features (e.g., language, date and decimal formatting, etc.) according to the profile 76.

In one example the connection formed between the gateway 21 and the back end ERP system 14 is a native connection such that the gateway 21 connects to databases of the ERP system 14 through the ERP system 14 and does not bypass ERP software to directly connect to the databases through an ODBC connection, for example. If a native connection is used, a greater quantity of ERP features may be available to the gateway 21, and a security model of the ERP system 14 can be strictly enforced.

Security

In one example MD5 hash password protection may be used to protect user passwords from administrators 13. In one example the platform 10 stores no usernames or passwords or any other ERP application instance credentials.

The computing device gateway 21 may include a BlackBerry® Enterprise Server, a corporate virtual private network (“VPN”) for iPhone® connectivity, or any other controlled gateway. In any configuration, the gateway 21 sits securely behind at least one firewall 23, which may be software-based, hardware-based, or both (see FIG. 1).

Although various numbers and letters may be used to indicate steps in this disclosure, it is understood that these are included for the sake of example only. It is understood that these numbers and letters are exemplary only and are not limiting in any way. Also, although embodiments of this invention have been disclosed, a worker of ordinary skill in this art would recognize that certain modifications would come within the scope of this invention. For that reason, the following claims should be studied to determine the true scope and content of this invention.

What is claimed is:

1. A method of providing enterprise resource planning (“ERP”) functionality to a computing device having a web browser, comprising:
A) organizing selected inputs and outputs of a selected ERP function into an application view in a rendering editor wherein no coding is required to create the view;
B) receiving user input from a computing device;
C) executing the selected ERP function on an ERP system in response to the user input;
D) rendering the view on a computing device gateway, the rendered view including data received from the ERP system via the selected ERP function, the computing device gateway being remote from the computing device; and
E) sending the rendered view to a remote user for display in a web browser on the computing device.

2. The method of claim 1, wherein the selected function includes at least one of a Business Application Programming Interface (“BAPI”), a remote function call (“RFC”) object, an Oracle catalog object, or another system catalog object.

3. The method of claim 1, wherein the computing device is a desktop computer or a mobile communication device having a web browser.

4. The method of claim 3, wherein the mobile communication device is a laptop, a mobile phone having network access, a personal digital assistant, or a tablet computer.

5. The method of claim 1, wherein said step (A) includes:
presenting a list of available inputs and outputs for the selected ERP function to a setup user; and
receiving a selection of at least one specified input and at least one specified output of the selected ERP function to be included in the view.

6. The method of claim 5, including:
receiving a selection of at least one input, at least one output, or both to be excluded from the view.

7. The method of claim 5, wherein said step (A) also includes:
receiving a selected label for at least one of the specified inputs or outputs that do not have an assigned constant or reserved word value, the label being displayed in proximity to its associated input or output in the rendered view of said steps (C) and (D).

8. The method of claim 7, wherein the constant or reserved word may include one of a date, a time, a username, a sequence value, or any other predefined word or number.

9. The method of claim 5, wherein said step (A) also includes:
receiving computing device identification information from the computing device, and receiving layout information from a rendering workbench, the computing device identification information and the layout information being used in said step and (D) to organize the data received from the ERP system via the selected function.

10. The method of claim 9, wherein the layout information includes display coordinates for the selection of specified inputs and outputs.

11. The method of claim 5, wherein one of the specified inputs is a signature input, the signature input presenting a free form input field operable to receive a remote user signature.

12. The method of claim 5, including:
receiving an assignment of at least one of a constant or reserved word value for an input or an output.

13. The method of claim 12, wherein the reserved word value includes one of a date, time, username, phone number, email address, or a mathematical function.

14. The method of claim 5, wherein said step (A) also includes:
receiving at least one of an input transformation or an output transformation for one or more of the inputs or outputs.

15. The method of claim 14, wherein the selected transformation applies a formatting constraint to its corresponding input or output value.

16. The method of claim 15, including at least one of receiving a selected quantity of rows to be presented in a data entry table, receiving a command to duplicate a portion of data from a first table to a second table, or receiving a command for an assigned label to be used as a table column heading.

17. The method of claim 1, including:
importing executable metadata from a selected function of an ERP system, the executable metadata including the inputs and outputs of said step (A).

18. The method of claim 17, wherein said step of importing executable metadata from a selected function of an ERP system may be selectively repeated for a plurality of ERP systems such that a selected view operable to communicate with a first of the plurality of ERP systems may invoke another view operable to communicate with a second of the plurality of ERP systems.

19. The method of claim 17, wherein said step of importing executable metadata from a selected function of an ERP system may be selectively repeated for a plurality of ERP systems such that a selected view may retrieve ERP data from any of the plurality of ERP systems.

20. The method of claim 17, wherein said step of importing executable metadata from a selected function of an ERP system includes:
presenting a list of ERP functions to an administrator;
receiving a selection of at least one ERP function from the administrator; and
importing executable metadata from the selection of at least one ERP function into a repository database, the repository database being in communication with the computing device gateway.

21. The method of claim 1, including:
assigning the view to at least one menu from which the view will be accessible;
enabling the view for at least one selected user role; and
disabling the view for at least one non-selected role.

22. The method of claim 21, wherein the role controls what views within the remote user's assigned group are presented to the remote user.

23. The method of claim 21, wherein the role also controls what instance of ERP system the selected view connects to.

24. The method of claim 21, wherein said step of enabling the view for at least one selected user group includes:
enabling the view for a first, testing role; and
enabling the view for a second, non-testing role different than the first, testing role, in response to a determination that the view successfully passed a testing procedure performed by a test user having the first, testing role.

25. The method of claim 1, wherein a plurality of views including the view of said step (A) belong to a package, the method including:
assigning a first state to the package in which the plurality of views are available to remote users having a first role and the plurality of views are hidden from remote users having a second role different from the first role; and
assigning a second state to the package in which the plurality of views are hidden from remote users having the first role and the plurality of views are available to remote users having the second role.

26. The method of claim 1, including:
selectively repeating said step (A) to create a plurality of views; and
creating at least one link between the plurality of views such that a first one of the selected views is operable to execute a second one of the selected views as an output of the first view.

27. The method of claim 1, including:
creating at least one search link between an input field of the view and a different view such that the different view functions as a ERP search view;
dynamically disabling output links of the ERP search view;
invoking the ERP search view to obtain a list of values for the input field from the ERP system;
presenting the obtained list of values for the input field to the remote user;
receiving a value selection from the remote user in response to the obtained list of values;
populating the input field with the value selection; and
performing the selected ERP function of said step (A) using the value selection in the input field.

28. The method of claim 27, wherein said step of receiving a value selection from the remote user in response to the obtained list of values includes:
defining a desired value as the value selection in response to the remote user selecting a link or button adjacent to a table row including the desired value.

29. The method of claim 1, wherein said step (C) includes:
F) establishing a connection from the computing gateway to the ERP system on behalf of the computing device using login credentials received in the user input;
G) commanding the ERP system to execute the selected function;
H) receiving data from the executed selected ERP function;
I) invoking an execution engine to generate browser data, said browser data being formatted for display on the browser on the computing device, said browser data including ERP data from said step (H); and
J) terminating the connection from step (F).

30. The method of claim 29, wherein the data received in said step (H) includes at least one of application function data, an error message, an informational message, or a return code.

31. The method of claim 29, wherein said step (I) is performed prior to performing said step (J).

32. The method of claim 1, wherein said step (D) is dynamically performed in response to the type of computing device providing input in said step (B).

33. An enterprise rendering platform for providing enterprise resource planning (“ERP”) functionality for a computing device having a web browser, comprising:
at least one ERP system storing enterprise data on at least one server;
a rendering workbench providing a GUI-based editor in which executable metadata for at least one selected ERP function is presented to a setup user, and in which a view for executing the ERP function may be created with no coding;
a repository storing the view and the executable metadata for the view; and
a computing device gateway operable to establish a connection with the ERP system on behalf of a computing device, the gateway invoking an execution engine to execute the ERP function to retrieve ERP data and render the view to include the retrieved ERP data, the view being formatted for a browser on the computing device.

34. The platform of claim 33, wherein the executable metadata includes a plurality of inputs and outputs for the selected ERP function, the view including a selection of enabled inputs and outputs from the executable metadata.

35. The platform of claim 34, wherein the view also includes at least one of an input transformation or an output transformation for one of the selected inputs or outputs.

36. The platform of claim 33, wherein the gateway finishes rendering the view prior to terminating its connection with the ERP system.

37. The platform of claim 33, wherein the selected function includes at least one of a Business Application Programming Interface (“BAPI”), a remote function call (“RFC”) object, an Oracle catalog object, or another system catalog object.

38. The platform of claim 33, including:
an administrative workbench operable to generate a list of available ERP functions, to import executable metadata from an ERP function selected from the list of available ERP functions, to enable the view including the selected ERP function for at least one selected user role, and to define at least one connection to each of the at least one ERP systems.

39. The platform of claim 33, wherein the rendering workbench is operable to create views that execute ERP functions from a plurality of ERP systems.

40. The platform of claim 33, wherein the rendering workbench is operable to organize a plurality of the views into menus, and operable to create links between the views such that a first view can invoke a second view.

41. The platform of claim 33, wherein the computing device is a desktop computer or a mobile communication device having a web browser.

42. A method of executing enterprise resource planning (“ERP”) functionality on a computing device having a web browser, comprising:
(A) receiving login credentials from a remote user of a computing device;
(B) determining a user role and an assigned ERP user instance in response to the login credentials;
(C) dynamically determining a menu to be displayed to the remote user based upon the remote user's assigned role and the remote user's assigned group;
(D) receiving a menu selection from the remote user, the menu selection selecting a view operable to execute an ERP function on an ERP system;
(E) retrieving a view definition for the ERP function from a repository database;
(F) invoking an execution engine to command the ERP system to execute the selected ERP function using executable metadata corresponding to the view definition; and
(G) dynamically formatting an indication of the performance of said step (F) for presentation in a browser on the computing device.

43. The method of claim 42, wherein the indication of said step (G) includes formatting the data received from the ERP system into HTML.

44. The method of claim 42, wherein the selected function includes at least one of a Business Application Programming Interface (“BAPI”), a remote function call (“RFC”) object, an Oracle catalog object, or another system catalog object.

45. The method of claim 42, including:
(H) transmitting the formatted ERP data to the computing device via a computing device gateway.

46. The method of claim 42, wherein said step (G) is performed prior to the execution engine terminating a connection with the ERP system made on behalf of the computing device.

47. A method of creating a view for providing enterprise resource planning (“ERP”) functionality for a computing device having a web browser, comprising:
presenting a list of available inputs and outputs for a selected ERP function to a remote user;
receiving a selection of at least one specified input and at least one specified output of the selected ERP function; and
organizing the selected inputs and outputs of the selected ERP function into a view in a rendering editor, the view being operable to command an ERP system to invoke the selected ERP function on behalf of a computing device, wherein the remote user may create the view without providing any code.

48. The method of claim 47, including:
selectively repeating said step (A) to create a plurality of views; and
creating at least one link between the plurality of views such that a first one of the selected views is operable to execute a second one of the selected views as an output of the first view.
